(19) United States
(12) Patent Application Publication
(10) Pub. No.: US 2025/0128368 A1
(43) Pub. Date: Apr. 24, 2025

(54) INSIDE OUT SPRING PLUNGER

(71) Applicant: STANDARD LIFTERS, INC., Grand Rapids, MI (US)

(72) Inventors: Scott M. Breen, Ada, MI (US); Joel T. Pyper, Holland, MI (US)

(73) Assignee: STANDARD LIFTERS, INC., Grand Rapids, MI (US)

(21) Appl. No.: 18/921,559

(22) Filed: Oct. 21, 2024

Related U.S. Application Data
(60) Provisional application No. 63/592,722, filed on Oct. 24, 2023.

(51) Int. Cl. B23P 15/24

(52) U.S. Cl. CPC B23P 15/24

(57) ABSTRACT

A spring plunger assembly can be used in manufacturing, machines, fixtures, etc. The spring plunger assembly has a spring that is located on the exterior of the plunger body. The spring plunger assembly includes a threaded section for engaging a threaded aperture.

### CROSS REFERENCE TO RELATED APPLICATION

Applicant hereby claims the priority benefits under the provisions of 35 U.S.C. § 119, basing said claim of priority on related U.S. Provisional Application No. 63/592,722 filed Oct. 24, 2023, which is incorporated in its entirety herein by reference.

### FIELD OF THE INVENTION

The present invention relates to spring plunger assemblies and the like and particularly to an inside out spring plunger and associated methods.

### BACKGROUND OF THE INVENTION

Spring plungers can be used to interact with components in machines, fixtures, and manufacturing dies/presses/molds. Spring plungers use a spring force to apply pressure to raise a ball/nose. As contact force puts pressure on the ball/nose of the spring plunger, it depresses the ball/nose causing the internal spring to compress. Spring plungers can be used to locate components as the ball/nose can locate a notched-out area in the component. Spring plungers can also provide support to components and/or be used to eject one component from another component.

Spring plunger assemblies have the advantage of being an all-in-one assembly that provides a spring force against another object. Currently available spring plungers typically have a low life cycle, often require special tools to install, and can mark the material they are pushing against. Thus, a spring plunger assembly that has a longer life cycle and has a large contact surface area to reduce or eliminate indenting the material would be advantageous.

### SUMMARY OF THE INVENTION

One object of the present invention is a metal forming die. The metal forming die has at least two mutually converging die members between which a stock strip is shifted to form parts from the stock strip. The metal forming die utilizes a spring plunger assembly. The spring plunger assembly comprises a plunger body with an outer end portion oriented toward the stock strip, an inner portion oriented away from the stock strip, and a medial portion between the outer end portion and the inner end portion. The outer end portion has a first width, and the medial portion has a second width that is smaller than said first width forming a first shoulder therebetween. The inner end portion has a third width that is smaller than the second width forming a second shoulder therebetween. The inner end portion includes a hexagonal exterior surface. The spring plunger assembly also has a retainer body with an outer end portion oriented toward the stock strip, an inner end portion oriented away from the stock strip, a threaded exterior surface, and a hexagonal opening in the outer end portion. The spring plunger assembly also has a spring member with an outer end portion oriented toward the stock strip, and an inner end portion oriented away from the stock strip. The outer end portion of the spring member contacts the first shoulder of the plunger body. The inner end portion of the spring member contacts the outer end portion of the retainer body. The hexagonal exterior surface of the inner end portion of the plunger body is received in the hexagonal opening in the outer end portion of the retainer body.

Another aspect of the invention is a spring plunger assembly. The spring plunger assembly has a plunger body with an outer end portion, an inner end portion, and a medial portion between the outer end portion and the inner end portion. The outer end portion has a first width. The medial portion has a second width that is smaller than the first width forming a first shoulder therebetween. The inner end portion has third width that is smaller than the second width forming a second shoulder therebetween. The inner end portion includes a hexagonal exterior surface and a flared section. The outer end portion has a hexagonal opening. The spring plunger assembly has a retainer body with an outer end portion, an inner end portion, and a threaded section on the exterior surface. The outer end portion has a hexagonal opening and the inner end portion has an opening with a narrowed section that contacts the flared section of the inner end portion of the plunger body. The spring plunger assembly includes a spring member with an outer end that contacts the first shoulder of the plunger body and an inner end that contacts the outer end portion of the retainer body.

Yet another aspect of the invention is a method for making a metal forming die having at least one die member with the improvement of at least one spring plunger assembly. The method comprises forming a plunger body with an outer end portion, an inner end portion, and a medial portion between the outer end portion on the inner end portion. The method includes forming a first shoulder between the outer end portion and the medial portion. The method includes forming a second shoulder between the inner end portion and the medial portion, and forming a hexagonal surface on portions of the inner end portion. The method includes forming a retainer body with an outer end portion with a hexagonal opening, an inner end portion with an opening having a narrowed section, and a threaded section on the exterior surface. A spring member is inserted over the medial portion and the inner end portion of the plunger body such that a first end of the spring member contacts the first shoulder. The hexagonal surface of the plunger body is placed into the hexagonal opening in the retainer body. The end of the inner end portion of the plunger body is then deformed. An aperture is formed in the die member, the aperture having a threaded section. The threaded section of the retainer body is then coupled to the threaded section of the aperture in said die member.

These and other advantages of the invention will be further understood and appreciated by those skilled in the art by reference to the following written specification, claims, and appended drawings.

### BRIEF DESCRIPTION OF THE DRAWINGS

FIG. 1 is a perspective view of the spring plunger assembly embodying the present invention;

FIG. 2 is an exploded perspective view of the spring plunger assembly shown in FIG. 1;

FIG. 3 is a side view of the spring plunger assembly shown in FIG. 1;

FIG. 4 is an exploded side view of the spring plunger assembly shown in FIG. 1;

FIG. 5 is a top perspective view of the spring plunger assembly shown in FIG. 1 installed in a die member; and

FIG. 6 is a cross-sectional view of the spring plunger assembly shown in FIG. 5.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

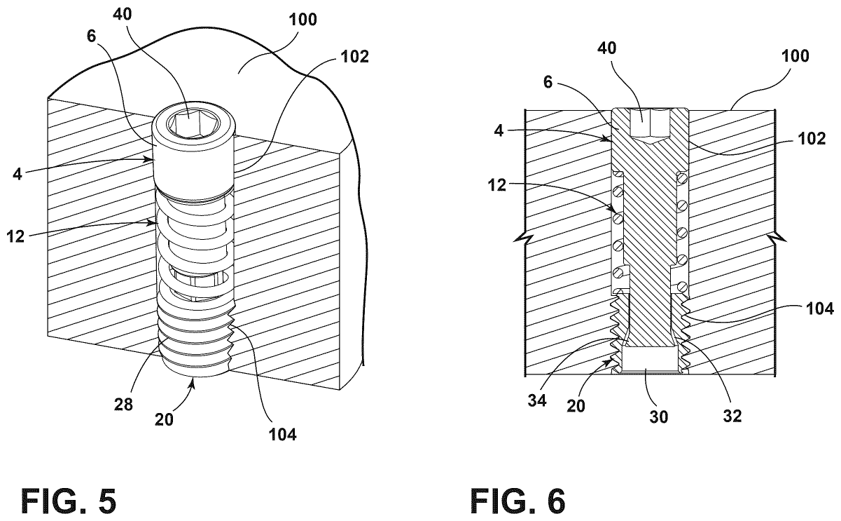

The reference numeral 2 refers to a spring plunger assembly embodying an aspect of the present invention. As illustrated in FIGS. 5 and 6, the spring plunger assembly 2 is particularly adapted for use with die members 100. The die members 100 can be part of a multi-stage, progressive metal forming die having at least two mutually converging and diverging die members between which an elongated stock strip is shifted longitudinally to form parts from the stock strip. The spring plunger assembly 2 can be used in other applications that need a plunger. The spring plunger assembly 2 can be used for clamping, holding, lifting, ejecting, dampening, pushing, crowding, oil breaking, and/or for other purposes. Moreover, while the embodiments shown herein illustrate the spring plunger assembly 2 being used in a vertical orientation, the spring plunger assembly 2 can also be used in horizontal and angled orientations.

The spring plunger assembly 2 includes a plunger body 4. The plunger body 4 has an outer end portion 6, an inner end portion 8, and a medial portion 10 that is between the outer end portion 6 and inner portion 8. The outer end portion 6 has a diameter or width that is larger than the diameter or width of the medial section 10 forming a first shoulder 50. The inner end portion 8 has a smaller diameter or width than the diameter or width of the medial portion 10 forming a second shoulder 52. While the outer end portion 6 and medial portion 10 are illustrated as being cylindrical, they can have other differently shaped exterior surfaces. Similarly, while the portion of the inner end portion 8 adjacent to the medial portion 10 is illustrated as being hexagonal, other differently shaped exterior surfaces can be used.

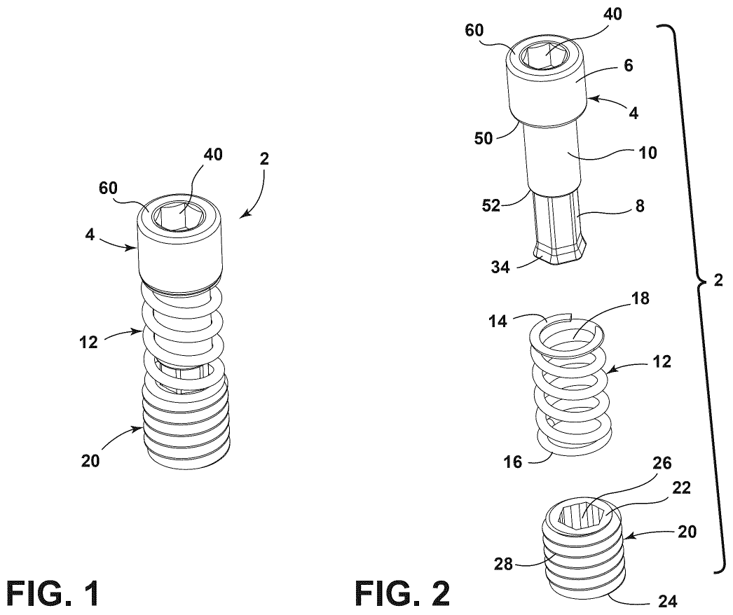

At least a part of the inner end portion 8 includes a hexagonal exterior surface as illustrated in FIGS. 1-5. The outer end portion 6 includes a hexagonal opening 40 in the top surface 60.

The spring plunger assembly 2 also has a retainer body 20. The retainer body 20 has an outer end portion 22 and an inner end portion 24. All or a part of the exterior surface 28 of the retainer body 20 is threaded. The outer end portion 22 has a hexagonal shaped opening 26. The inner end portion 24 has an opening 30 that includes a narrowed section 32. The narrowed section 32 could include a tapered surface and/or an internal shoulder. The retainer body 20 could include a pocket for receiving an insert, such as a nylon locking insert or other insert that helps lock the spring plunger assembly 2 into a threaded aperture.

A spring member 12 has an outer end 14, an inner end 16, and a hollow interior 18. When the spring plunger assembly 2 is fully assembled, the outer end 14 will contact the first shoulder 50 on the plunger body 4. The inner end 16 will contact the outer end portion 22 of the retainer body 20. While the inner end 16 is illustrated as contacting the terminal end of the outer end portion 22, the inner end 16 of the spring member 12 could contact another part of the outer end portion 22 including a shoulder formed on the exterior of the retainer body 20.

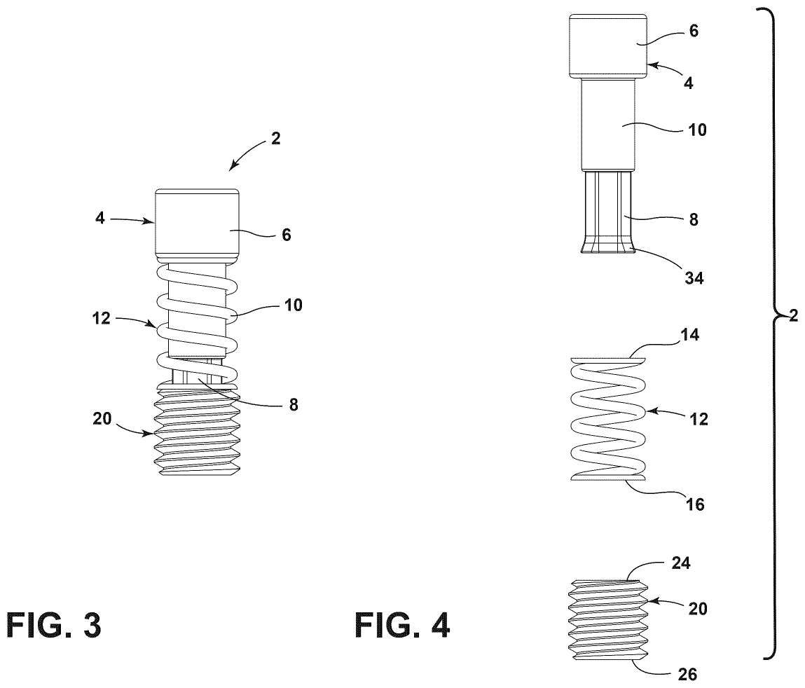

The spring member 12 is inserted over the medial portion 10 of the inner end portion 8 of the plunger body 4, as illustrated in FIG. 3. The hexagonal opening 26 of the retainer body 20 is then inserted over the hexagonally shaped part of the inner end portion 8 of the plunger body 4. The spring member 12 is compressed so that a portion of the inner end portion 8 can be deformed. The deformed section 34 of the inner end portion 8 is then received in the narrowed section 32 of opening 30 to couple the retainer body 20 to the plunger body 4 when the spring member 12 is not fully compressed. In the illustrated embodiment, an orbital forming machine/tool is used to create the flared/deformed section 34. However, other methods/tools can be used to create the flared/deformed section 34.

Once the spring plunger assembly 2 is fully assembly, it is ready to be installed in a die member 100 or other structure. An aperture 102 is formed in the structure. The aperture 102 includes a threaded section 104. A hex tool engages the hexagonal opening 40 to rotate the spring plunger assembly 2 until the threaded exterior surface 28 of the retainer body 20 is coupled with the threaded section 104 of the aperture 102.

The spring plunger assembly 2 will rise above the top surface of the die member 100 (or other structure) when the spring member 12 expands and can be flush with the top surface of the die member 100 when the spring is compressed. FIG. 6 illustrates the start of the spring member 12 compression.

In the illustrated embodiment, the retainer body 20 and the plunger body 4 are made from hardened steel. These parts may be machined or formed by a cold heading process. The spring member 12 is illustrated as being made from metal, but can be made from other durable and resilient materials.

In the foregoing description, it will be readily appreciated by those skilled in the art that modifications may be made to the invention without departing from the concepts disclosed herein. Such modifications are to be considered as included in the following claims, unless these claims by their language expressly state otherwise.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “connected” or “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A metal forming die having at least two mutually converging die members between which a stock strip is shifted to form parts from the stock strip, the improvement of a spring plunger assembly, comprising:
a plunger body with an outer end portion oriented toward the stock strip, an inner portion oriented away from the stock strip, and a medial portion between the outer end portion and the inner end portion; wherein:
said outer end portion has a first width, said medial portion has a second width that is smaller than said first width forming a first shoulder therebetween;
said inner end portion has a third width that is smaller than said second width forming a second shoulder therebetween;
said inner end portion including a hexagonal exterior surface;
a retainer body having an outer end portion oriented toward the stock strip, an inner end portion oriented away from the stock strip, a threaded exterior surface, and a hexagonal opening in said outer end portion;
a spring member with an outer end portion oriented toward the stock strip, an inner end portion oriented away from the stock strip;
wherein said outer end portion of said spring member contacts said first shoulder of said plunger body, and said inner end portion of said spring member contacts said outer end portion of said retainer body; and
wherein said hexagonal exterior surface of said inner end portion of said plunger body is received in said hexagonal opening in said outer end portion of said retainer body.

2. The metal forming die of claim 1, wherein the inner end portion of said retainer body includes an opening with a narrowed section.

3. The metal forming die of claim 2, wherein a terminal end of said inner portion of said plunger body is deformed to create a flared portion that contacts said narrowed section of said retainer body to couple said plunger body and said retainer body.

4. The metal forming die of claim 1, wherein said plunger body is a single piece of hardened steel.

5. The metal forming die of claim 1, wherein said threaded retainer is a single piece of hardened steel.

6. The metal forming die of claim 1, wherein said outer end portion of said plunger body includes a hexagonal opening.

7. The metal forming die of claim 1, wherein said threaded exterior surface of said retainer body is received in a threaded section of an opening of one of said die members.

8. A spring plunger assembly, comprising:
a plunger body with an outer end portion, an inner end portion, and a medial portion between said outer end portion and said inner end portion;
wherein said outer end portion has a first width;
wherein said medial portion has a second width that is smaller than said first width forming a first shoulder therebetween;
wherein said inner end portion has third width that is smaller than said second width forming a second shoulder therebetween;
wherein said inner end portion includes a hexagonal exterior surface and a flared section;
wherein said outer end portion as a hexagonal opening;
a retainer body having an outer end portion, an inner end portion, and a threaded section on the exterior surface;
wherein said outer end portion has a hexagonal opening;
wherein said inner end portion has an opening with a narrowed section that contacts said flared section of said inner end portion of said plunger body; and
a spring member with an outer end that contacts said first shoulder of said plunger body and an inner end that contacts the outer end portion of said retainer body.

9. The spring plunger assembly of claim 8, wherein said plunger body is hardened steel.

10. The spring plunger assembly of claim 9, wherein said retainer body is hardened steel.

11. The spring plunger assembly of claim 9, wherein said threaded section of said retainer body includes an insert.

12. The spring plunger assembly of claim 11, wherein said insert is a self-locking nylon patch.

13. A method for making a metal forming die having at least one die member with the improvement of at least one spring plunger assembly, comprising:
forming a plunger body with an outer end portion, an inner end portion, and a medial portion between said outer end portion on said inner end portion, including:
forming a first shoulder between said outer end portion and said medial portion;
forming a second shoulder between said inner end portion and said medial portion;
forming a hexagonal surface on portions of said inner end portion;
forming a retainer body with an outer end portion with a hexagonal opening, an inner end portion with a opening having a narrowed section, and a threaded section on the exterior surface;
inserting a spring member over said medial portion and said inner end portion of said plunger body such that a first end of said spring member contacts said first shoulder;
placing said hexagonal surface of said plunger body into said hexagonal opening in said retainer body;
deforming the end of said inner end portion of said plunger body;
forming an aperture in said die member, said aperture having a threaded section; and
coupling the threaded section of said retainer body to the threaded section of said aperture in said die member.

14. The method of making a metal forming die of claim 13, wherein said forming a plunger body includes forming a hexagonal opening in said outer end portion.

15. The method of making a metal forming die of claim 14, including inserting a hexagonal tool into said hexagonal opening to couple said spring plunger assembly to said die member.

16. The method of making a metal forming die of claim 13, wherein said plunger body is formed by a cold heading process.

17. The method of making a metal forming die of claim 13, including forming a pocket in said threaded section of said retainer body for an insert.

18. The method of making a metal forming die of claim 17, wherein said inert is a nylon patch.

19. The method of making a metal forming die of claim 13, wherein said deforming step is done with an orbit forming machine.

20. The method of making a metal forming die of claim 13, wherein said retainer body is made from hardened steel.
